(19) United States
(12) Patent Application Publication
(10) Pub. No.: US 2004/0246716 A1
(43) Pub. Date: Dec. 9, 2004

(54) Lighting installation for household appliances

(76) Inventors: Stefan Hubert, Engelstadt (DE); Werner Henkel, Ingelheim (DE)

Correspondence Address: Pauley Petersen & Erickson, 2800 W. Higgins Road, Suite 365, Hoffman Estates, IL, 60195, US

(21) Appl. No.: 10/826,154

(22) Filed: Apr. 16, 2004

(30) Foreign Application Priority Data
Apr. 17, 2003 (DE) 103 17 657.8

(51) Int. Cl. F21S 8/00

(52) U.S. Cl. 362/227

(57) ABSTRACT

A lighting installation for household appliances having an interior in which a bracket for receiving support shelves is arranged. The lighting arrangement includes an illuminating device integrated into at least a partial area of the bracket or entirely into the bracket. The illuminating device can include a fluorescent tube or an arrangement of a plurality of light-emitting diodes. Alternatively, at least a partial area of the bracket can be embodied as an optical waveguide, into which the light from a light source not arranged in the interior can be introduced.

### BACKGROUND OF THE INVENTION

1. Field of the Invention

This invention relates to a lighting installation for household appliances, in which interior a bracket for receiving support shelves is arranged.

2. Discussion of Related Art

The prior art teaches attaching a light to a lateral wall of an interior for lighting the interior of refrigerators. This light is switched on by a contact when the refrigerator door is opened. The arrangement of a light on a lateral wall has one disadvantage in that large containers for foods to be refrigerated or food packages cover the light. This results in a noticeable reduction of light output because a large portion of the refrigerator interior is shaded by foods to be refrigerated. Because known lights are customarily embodied as incandescent bulbs, it is also disadvantageous in that the heat generated by the incandescent bulbs unnecessarily heats the cooling chamber.

From German Patent Reference DE 102 16 769.9, a bracket for support shelves in household appliances is known, which has a profiled rail extending substantially vertically mounted in an interior of a refrigerator. In addition, the bracket has a support element, to which a support shelf is attached and which can be selectively displaced along the profiled rail, or can be fixed in place on the profiled rail. The support element can be fixed in place on the profiled rail to prevent a movement along the profiled rail. Such a bracket for support shelves in household appliances allows flexible setting of the height of the support shelves. However, with such a bracket arrangement it is not easy to overcome the disadvantages of a light attached to a lateral wall.

### SUMMARY OF THE INVENTION

It is one object of this invention to provide a lighting arrangement for household appliances, which makes it possible to illuminate the interior of the household appliance as evenly as possible, and to greatly reduce the heat output as compared to conventional incandescent bulbs.

This object of this invention is attained by embodiments of this invention as described in this specification and in the claims.

Accordingly, the lighting arrangement includes illuminating means which are integrated into at least a partial area of the bracket, or entirely into the area of the bracket. The illumination of the interior of the household appliance from substantially only one spot-like location is avoided with such an arrangement. With the lighting arrangement in accordance with this invention, the illumination of the interior occurs from at least a partial area of the bracket. Also, the heat transfer into the interior is reduced because the illuminating means are integrated into at least a partial area of the bracket or entirely into it, and no conventional incandescent bulbs are used in the interior.

In accordance with one embodiment of this invention, the illuminating means include a fluorescent tube which is particularly distinguished by a very low heat output into the interior of the household appliance.

Alternatively, the illuminating means can include a plurality of light-emitting diodes. It is thus possible to arrange 10 to 100 LEDs in the form of an LED array. LEDs are distinguished by very low energy consumption, low heat output and a long service life.

The LEDs used are available in various colors, so that the emitted light appears in a corresponding color. With this it is possible to suggest defined associations, for example with the idea of “freshness” or “cold”, to the user by the blue tint of the color. Thus it is possible for all further lighting arrangements themselves used in accordance with other embodiments, or filter devices attached to the lighting arrangements, to be in colors. In contrast to conventional lighting arrangements, it is possible with the different colorations of the emitted light to realize different design variations for household appliances.

In accordance with a particularly preferred embodiment, at least a partial area of the bracket itself can be embodied as an illumination means. An illumination of the interior as evenly as possible is thus assured.

At least a partial area of the bracket can be embodied as an optical waveguide, into which the light from a light source can be introduced. In a particularly advantageous manner the light source intended for introducing the light can be arranged outside of the interior of the household appliance. With such an arrangement the light source which emits heat during its operation is not located in the interior, and the introduction of light is provided from outside the interior, and heat output into the interior by the illuminating means is completely avoided.

A coupling element can be arranged between the light source and the optical waveguide for introducing the light into the optical waveguide. In this case a filter element, arranged on the coupling element or the optical wave guide, can also be provided, which generates and introduces colored light, even when using a conventional white incandescent bulb.

In a particularly simple embodiment, the portion of the bracket embodied as an optical waveguide can consist of a colored transparent material, for example glass or plastic. Thus the use of colored illuminating means is not necessary. In the event of a failure of the illuminating means it is thus possible to use an inexpensive conventional illuminating means emitting white light, for example an incandescent bulb or fluorescent tube.

In accordance with a preferred embodiment, the bracket has a profiled rail, which is mounted in the interior of the household appliance and extends substantially vertically. A support element for holding a support shelf is provided on the profiled rail. The support element can be displaced along the profiled rail, or can be fixed in place on the profiled rail. It is thus possible with this to use clamping or snap-in connectors. In an advantageous manner, the illuminating means are embodied on at least a partial area of the profiled rail.

The profiled rail can be arranged on the rear wall of the household appliance opposite the door opening. This allows a further embodiment, or an easy connection of the illuminating means, in or behind the rear wall of the household appliance.

### BRIEF DESCRIPTION OF THE DRAWINGS

This invention is described in greater detail in view of preferred embodiments, making reference to the drawings, wherein:

FIG. 1 shows a refrigerator in a schematic, perspective view and in partial section, and in the interior of the refrigerator a bracket is arranged for receiving support shelves, into which a lighting arrangement embodied as a fluorescent tube is integrated in accordance with one embodiment; and

FIG. 2 shows a schematic lateral view of an optical waveguide in accordance with a further embodiment, which is connected by a coupling element to an incandescent bulb for lighting the interior of a household appliance.

### DESCRIPTION OF PREFERRED EMBODIMENTS

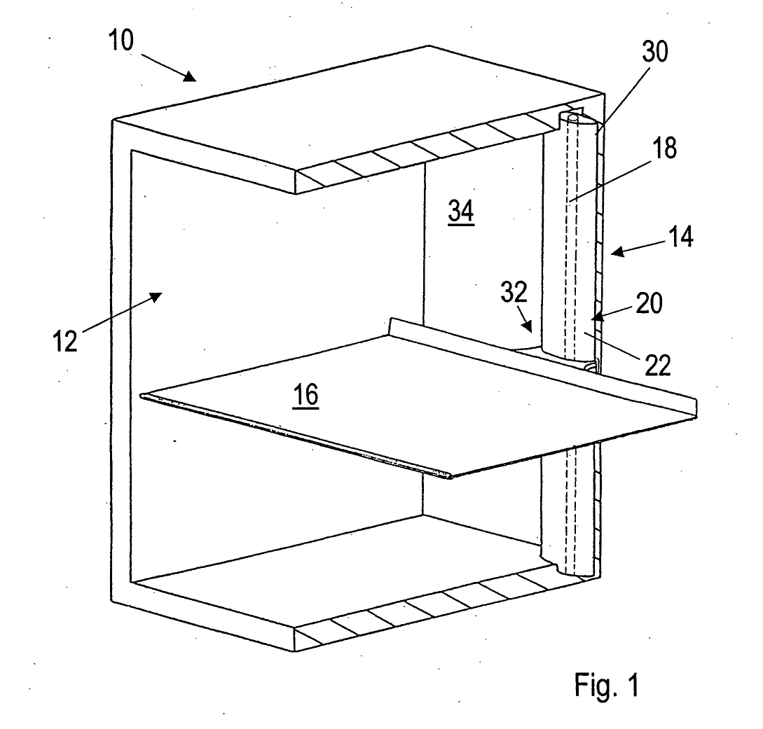

In a schematic, perspective view and in partial section, FIG. 1 shows a refrigerator 10 having an interior 12 in which a bracket 14 is arranged for receiving support shelves 16. The bracket 14 has a profiled rail 30, which is mounted, extending substantially vertically in the interior 12 of the household appliance 10, on the rear wall 34 of the household appliance 10 located opposite the door opening. Alternatively, it is possible to provide a plurality of vertically extending profiled rails arranged on different lateral walls in the interior of the refrigerator.

A support element 32 for holding the support shelf 16 is arranged on the profiled rail 30. The support element 32 can be displaced along the profiled rail 30 and can be fixed in place on the profiled rail 30 at a desired height by releasable fastening means which are not shown in the drawings.

The profiled rail 30 has a transparent hollow body which is made, for example, of a plastic material reinforced by metal spars, and which has a substantially oval cross sectional face. Alternatively, it is possible to make the profiled rail 30 of aluminum with an extrusion process. The hollow body of the profiled rail 30 extends vertically on the inner rear wall 34 in the interior 12 of the refrigerator 10. A fluorescent tube 18 is arranged in the interior of the hollow body of the profiled rail 30 in at least the partial area represented. The transparent wall of the profiled rail 30 has a bluish tint, so that the interior 12 of the refrigerator 10 is illuminated in a bluish light. It is possible with the blue tint to suggest defined associations, for example with the idea of “freshness” or “cold”, to the user.

In an alternative embodiment not shown in the drawings, an arrangement of 10 to 100 LEDs in the form of an LED array is provided in the hollow body of the profiled rail 30. The transparent wall of the profiled rail 30 has a clear or white color, while the LEDs used can emit a predetermined color.

In a further embodiment not shown in the drawings, the profiled rail 30 is designed as an optical waveguide made of a glass material.

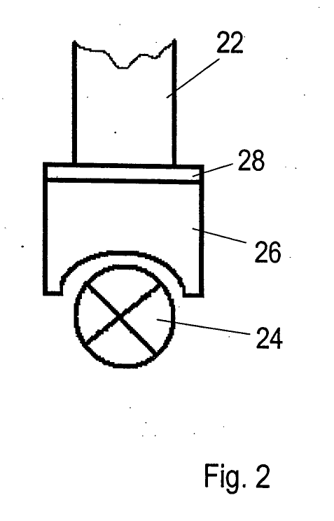

In a schematic lateral view, FIG. 2 shows an optical waveguide 22 for the illumination of the interior of a household appliance, connected to an incandescent bulb 24 by a coupling element 26. The optical waveguide 22 can be connected to a profiled rail 30 designed as an optical waveguide, or can make a transition into it. A coupling element 26 for introducing the light is arranged between the incandescent bulb 24 and the optical waveguide 22. A filter element 28, arranged on the coupling element 26 or on the optical waveguide 22, converts the light, which is colorless when being introduced, into colored light. The profiled rail 30 made of a colorless clear glass material shines in the color predetermined by the filter element 28.

However, it is also possible to omit the filter element 28, in which case at least a portion of the profiled rail 30 is colored in an appropriate color for the desired coloration of the light emitted by the profiled rail 30.

The incandescent bulb 24 is arranged outside of the interior 12 in the rear wall of the refrigerator 10, so that no heat occurs in the interior 12 when the light is introduced into the interior 12.

German Patent Reference 103 17 657.8, the priority document corresponding to this invention, and its teachings are incorporated, by reference, into this specification.

What is claimed is:

1. A lighting installation for household appliances (10) having an interior in which a bracket (14) for receiving support shelves (16) is arranged, the improvement comprising:
the lighting arrangement having an illuminating device (18) integrated one of entirely into and into at least a partial area (20) of the bracket (14).

2. The lighting installation in accordance with claim 1, wherein the illuminating device (18) includes a fluorescent tube.

3. The lighting installation in accordance with claim 1, wherein the illuminating device (18) includes a plurality of light-emitting diodes.

4. The lighting installation in accordance with claim 3, wherein the light-emitting diodes are arranged in a form of an LED array.

5. The lighting installation in accordance with claim 4, wherein one of the lighting device (18) and a filter device attached to the lighting device (18) is designed in a color, so that emitted light appears in a corresponding color.

6. The lighting installation in accordance with claim 5, wherein at least a partial area (20) of the bracket (14) is embodied as an illumination device.

7. The lighting installation in accordance with claim 6, wherein at least a partial area (20) of the bracket (14) is embodied as an optical waveguide (22) into which light from a light source (24) is introduced.

8. The lighting installation in accordance with claim 7, wherein the light source (24) is arranged outside of the interior (12) of the household appliance (10).

9. The lighting installation in accordance with claim 8, wherein a coupling element (26) is arranged between the light source (24) and the optical waveguide (22) for introducing the light from the illuminating device (18), by which colored light is generated by a filter element arranged on one of the coupling element (26) and the optical wave guide (22).

10. The lighting installation in accordance with claim 9, wherein a portion of the bracket (14) embodied as an optical waveguide (22) is of a colored transparent material.

11. The lighting installation in accordance with claim 10, wherein the bracket (14) has a profiled rail (30) mounted in the interior (12) of the household appliance (10) and extends substantially vertically, a support element (32) for holding the support shelf (16) is one of displaceable along the profiled rail (30) and fixable in place on the profiled rail (30), and the illuminating device (18) is on at least a partial area of the profiled rail.

12. The lighting installation in accordance with claim 1, wherein the profiled rail (30) is arranged on the rear wall (34) of the household appliance (10) opposite a door opening.

13. The lighting installation in accordance with claim 1, wherein one of the lighting device (18) and a filter device attached to the lighting device (18) is designed in a color, so that emitted light appears in a corresponding color.

14. The lighting installation in accordance with claim 1, wherein at least a partial area (20) of the bracket (14) is embodied as an illumination device.

15. The lighting installation in accordance with claim 1, wherein at least a partial area (20) of the bracket (14) is embodied as an optical waveguide (22) into which light from a light source (24) is introduced.

16. The lighting installation in accordance with claim 15, wherein the light source (24) is arranged outside of the interior (12) of the household appliance (10).

17. The lighting installation in accordance with claim 1, wherein a coupling element (26) is arranged between a light source (24) and an optical waveguide (22) for introducing light from the illuminating device (18), by which colored light is generated by a filter element arranged on one of the coupling element (26) and the optical wave guide (22).

18. The lighting installation in accordance with claim 7, wherein a portion of the bracket (14) embodied as an optical waveguide (22) is of a colored transparent material.

19. The lighting installation in accordance with claim 1, wherein the bracket (14) has a profiled rail (30) mounted in the interior (12) of the household appliance (10) and extends substantially vertically, a support element (32) for holding the support shelf (16) is one of displaceable along the profiled rail (30) and fixable in place on the profiled rail (30), and the illuminating device (18) is on at least a partial area of the profiled rail.
